(19) United States
(12) Patent Application Publication
(10) Pub. No.: US 2009/0176639 A1
(43) Pub. Date: Jul. 9, 2009

(54) Method and furnace with series-arranged baths for producing glass frits

(75) Inventors: Remi Jacques, Estrees Saint-Denis (FR); Jerome Lalande, Chamigny Sur Marne (FR); Laurent Teyssedre, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/658,760

(22) PCT Filed: Jul. 26, 2005
(86) PCT No.: PCT/FR2005/050616

§ 371 Date: Nov. 24, 2008

(30) Foreign Application Priority Data
Jul. 28, 2004 (FR) 0451687

(51) Int. Cl. C03C 8/14; C03B 17/00; C03B 5/04; C03B 3/00

(52) U.S. Cl. 501/17; 65/66; 65/356; 65/335

(57) ABSTRACT

The invention relates to a furnace for continuously melting a silica-containing compound comprising at least two series-arranged baths each of which is provided with at least one burner submerged into molten material. Said invention also relates to a method for producing silica-containing compounds, the silica and the melt thereof being loaded into the first bath. The invention is intentionally adapted for the high performance production of frits for re-enameling ceramic products (sandstone, faience and burnt clay) at low temperatures and a fast transition time.

The invention relates to a furnace comprising several tanks in series, each equipped with at least one submerged burner, for effective melting, that is to say with a low stones content and for a low energy consumption, the compositions containing silica. The invention relates more particularly to the production of glass frits used in the composition of enamels, glazes and slips for enameling ceramics.

An enamel is a suspension containing finely ground glass batch materials (sometimes called “glass fluxes”) and agents intended to confer certain optical properties, such as color, opacity, reflection or scattering (matt or shiny appearance). The enamel is intended to be applied as a layer on a support, which may be a ceramic (in the case of glazing), glass or metal, by processes such as “curtain coating” or screen printing, and then to be “fired” so as to form, after evaporation of the solvent and melting of the glass batch materials, a fine glassy layer whose purpose is principally decorative. The enameling of ceramics, such as sandstone, earthenware or terracotta used as tiling, pottery, tiles, sanitary ware or else vessels, also has, apart from a decorative function, an impermeablizing function and sometimes the function of providing resistance to various chemicals.

The glass batch materials in the enamel composition before firing may be natural or artificial raw materials, such as quartz sand, feldspars, nepheline or limestone. These raw materials must then react together during the step of firing the enamel in order to form a glass. This requires quite lengthy firing times. In addition, certain raw materials, such as boron-containing compounds (for example sodium borate), are soluble in the solvents employed. An increasingly used alternative consists in employing glass frits, either partly or completely (in the latter case, the composition of the frit has the final composition of the fired enamel). The glass frits used in enamel compositions are very finely ground so as to be able to melt and coat the glass, ceramic or metal substrate in a very short time, thus reducing the enamel firing time and therefore the manufacturing cost and/or possible deformation of the substrate at the firing temperatures.

A continuous melting process commonly employed for the manufacture of glass frits for enameling ceramics consists in impacting a heap formed from the batch using an overhead burner, generally placed in the roof of the furnace. The glass, which rapidly forms owing to the effect of the heat, then flows as a thin layer toward the outlet of the furnace, the floor of which is inclined so as to promote this flow. There are many drawbacks with this type of melting process: in particular, the impact of the flame results in a considerable amount of fly-off material, mainly toxic boron and zinc compounds, commonly employed in the composition of glazing frits. Moreover, the short residence time of the glass in the furnace generates a large amount of batch stones and poor chemical homogeneity and requires the raw materials, especially the silica sand, to be ground, making the cost of the composition higher. The median particle size of the silica sand used is less than 100 microns, often even less than 50 microns or even 20 microns. Furthermore, owing to the small thickness of the glass “bath”, the temperature cannot be precisely controlled and the thermal homogeneity is quite poor.

The invention solves the abovementioned problems. The process according to the invention results, with high productivities, low fly-off and short residence times of the batch materials, in glass compositions that have few or no batch stones and are chemically very homogeneous. The process according to the invention also makes it possible to achieve a low, uniform and precisely controlled temperature. This has the advantage, explained later, of being able to crystallize certain desirable phases in a very controlled manner. In addition, the transition times, enabling production to pass from one composition to another, are very short. This allows great flexibility in the production of a wide range of compositions. Finally, since the invention generally enables a lower temperature to be used, the use of less expensive materials for constructing the furnace is permitted.

The arrangement according to the invention of several reactors in series allows the temperature of the reactors to be considerably lowered while maintaining the quality of the end product, expressed in terms of batch stones, homogeneity and even general level of blisters (i.e. the quantity of bubbles remaining trapped in the end product). This is a major advantage when the materials to be melted contain volatile components, such as boron oxide, zinc oxide or the like, since in this case, the emission into the flue gases, which in general depends exponentially on the temperature, is limited. The scrubbing of the flue gases is thereby facilitated. In the case of the manufacture of ceramic enameling frits, which frequently contain boron oxide and/or zinc oxide, the latter may thus be introduced at low temperature. This results in a considerable reduction in the fly-off of polluting and potentially toxic materials.

The lower temperature of the reactors also has the advantage that there is less infiltration of glass into the interstices of the refractories of the furnace. This is because the infiltrated molten substance solidifies more quickly in the refractory owing to the lower temperature and blocks the interstice at a point closer to the inside of the furnace.

Another advantage of the invention is the fact that, as glasses and especially frits are in general highly corrosive toward refractory materials, a low temperature level allows the lifetime of the furnace to be extended. Thus, it is possible to use a conventional glassmaking construction namely one with a refractory in contact with the molten glass, an insulator being placed behind said refractory. It is also possible to choose, for all or only part of the furnace, a solution consisting of the use of an assembly comprising a refractory in contact with the molten glass, a cooled metal plate being placed behind said refractory, this solution being recommended when lifetime is given preference over specific consumption. Furthermore, this solution eliminates the risk of compositions flowing out of the furnace owing to their high fluidity. The cooling may be provided by making water run down over the external part of the metal plate or by a continuous water circulation pipe wound around and welded to said plate. According to another embodiment, the refractory lining is advantageously made of cast refractory concrete and is monolithic in character at least one horizontal level. The metal casing may also contribute to cooling the furnace by being provided with cooling fins, at least one of the fins preferably being at least partly horizontal and going around the furnace about its vertical axis. This configuration means that the metal casing does not have to be water-cooled, thereby making substantial energy savings.

The process according to the invention involves the continuous melting of a silica-containing composition in a furnace comprising at least two tanks and preferably three tanks in series, said tanks each comprising at least one burner submerged in the molten materials, the first tank generally being heated to a higher temperature than the first. The first tank is charged with silica and silica fluxing agent. In general, most of the silica for the frit, e.g. at least 80% and preferably at least 90% by weight of the silica for the frit, and preferably all of it, is charged into the first tank, which is generally hotter than the other tank(s) of the furnace. Generally at least 80% and preferably at least 90% by weight of the silica fluxing agent, or even all of it, is charged into the first tank.

The submerged burners have two functions, namely to heat the batch materials and to homogenize the composition. Because of the vigorous agitation that they produce, the rubbing and splashing of the molten materials against the walls usually leads to said walls being worn away, not only below the level of the molten materials, but also above them, especially at the roof, owing to the substantial splashing. However, the invention allows this phenomenon to be significantly reduced owing to the lower temperatures needed, especially when only the first tank has a high temperature for effectively melting most of the silica, the other tank(s) following thereafter being heated to a more moderate temperature. Because of this more moderate temperature, the molten material is more viscous and the splashing and movements of molten material are less pronounced, resulting in lower wear of the walls. In addition, the more viscous molten materials show a smaller tendency to insinuate into the interstices or defects of the walls. This also makes it easier to purge the furnace when changing the composition to be manufactured (reduction in transition time). In general, the first tank is heated to the highest temperature of the furnace, the other tank(s) having either the same temperature or a lower temperature. In general, the tanks or tanks after the first one have a lower temperature than the first, this difference generally being at least 40° C. and possibly, for example, up to 200° C. Preferably, when the process according to the invention uses three tanks, the temperature difference between the first and second tanks is between 40 and 70° C. and the temperature difference between the second and third tanks is greater than 100° C.

In general, the first tank is heated to a temperature ranging from 1000 to 1350° C., and more generally from 1230 to 1350° C., and the furnace comprises at least one other tank heated to a temperature below 1300° C. The furnace therefore generally comprises at least two tanks having between them a temperature difference of at least 40° C., the first receiving most of the silica and being the hottest. According to the invention, the use of just one tank heated to the highest temperature, followed by another tank at a lower temperature, allows the batch materials to be effectively melted with a very low, or even zero, final stone content. The silica particles are predominantly melted in the first tank. Those particles that have not been entirely melted in the first tank are melted in at least one other tank that follows. Overall, the invention reduces the use of expensive construction materials owing to the lower temperatures needed and/or the high production rates, especially when at least one tank operates at a temperature below that of the first tank, while eliminating batch stones, and with a high productivity.

The first tank is equipped with means for charging the furnace with batch materials. In general, most of the silica needed to produce the final composition together with the silica fluxing agent are introduced into this first tank. This fluxing agent may be Na₂CO₃, which is converted to Na₂O during vitrification, or preferably CaCO₃, which is converted to CaO. Ceramic enameling frits have in fact quite a low content of alkaline metal oxides, since these give the glass a high expansion coefficient, generating cracks or crazing owing to poor matching between the expansion coefficient of the enamel and that of its support. A fluidizing agent, such as B₂O₃ or ZnO, may also be introduced into this first tank. The first tank may also be fed with combustible waste, such as for example plastics, coal, spent oils, tire scrap, etc., so as to reduce the energy costs. The raw materials may be ground or micronized and have a fine particle size. However, thanks to its efficiency in melting the glass batch materials (with a low stone content), the furnace may also be fed with natural raw materials with a relatively coarse particle size. This provides, in the case of melting ceramic enameling frits, a certain economic advantage over the abovementioned process in which the short residence time and the absence of agitation require the raw materials to be ground. In particular, thanks to the use of this process, very low-cost coarse sand can be used, whereas the abovementioned process can melt only finely ground silica. Such coarse sand has for example a median particle size of more than 100 microns, or more than 200 microns and even more than 300 microns. As an alternative or in combination, the process according to the invention also allows the use of barely fusible raw materials. Owing to the intense degree of agitation provided by the submerged burners, it is not absolutely essential to mix the raw materials before they are charged into each tank. This advantage may for example be used to preheat the silica, separately from the other raw materials, by the combustion flue gases, resulting in a lower energy cost.

All the glass batch materials may be introduced into the first tank. However, it is preferred to introduce the batch materials, other than silica, the silica fluxing agent and the fluidizing agent into at least one tank located downstream of the first tank, and preferably into the tank located directly after the first tank, that is to say the second tank. The addition of the batch materials other than silica, silica fluxing agent and fluidizing agent into a tank downstream of the first tank makes it possible to reduce the fly-off effect in these materials. This is because, since the first tank is the hottest one of the furnace, the introduction of these materials into another tank reduces the amount of fly-off of these materials because of the lower temperature of the feed tank.

Preferably, the fluidizing agent (especially B₂O₃ and/or ZnO) is also added to at least one tank located downstream of the first tank, and preferably to the tank located directly after the first tank, that is to say the second tank. This is more particularly recommended if the first tank is hotter than the other tank(s) since, if the fluidizing agent is added to the first tank, the viscosity of the glass, already quite low owing to the high temperature, is further reduced. This has the consequence of promoting movements of the molten glass and thereby further aggravating the problem of wall abrasion in the first tank. The fact that the fluidizing agent is not introduced into the first tank allows a higher viscosity to be maintained in the first tank. Moreover, since the fluidizing agent is introduced into at least one other tank at a lower temperature than the first tank, it is introduced at a point where the viscosity of the glass is higher owing to the lower temperature, and the reduction in viscosity that this addition provides can therefore be more easily tolerated.

The process according to the invention also has the advantage of being able to form glass frits also containing agents for modifying the optical properties. These pigments, opacifiers or delustrants are usually purchased separately and then added to the ground frit at the moment of producing the enamel or, sometimes, obtained by crystallization from the glass frit. They may be pigments that are insoluble in the frit at the firing temperature, the size of the pigments being of the order of magnitude of the wavelength of the light (about 04 μm) so as to optimally scatter said light. Within the context of ceramic enameling, these pigments are generally doped spinels, zirconias or zircons, such as vanadium-doped or praseodymium-doped CoAl₂O₄, 3CaO.Cr₂O₃.3SiO₂, ZrSiO₄, vanadium-doped ZrO₂ or (Zn,Fe)(Fe,Cr)₂O₄. As regards the opacifying agents, these comprise a variety of white pigments, such as ZrO₂, TiO₂ or ZrSiO₄. These opacifying agents may be added to the frit before enameling or may be formed from the frit by crystallization of certain elements of said frit. Of course, the latter case is economically more advantageous since it allows in situ formation of the opacifying agents and avoids having to purchase said agents separately. Likewise, the delustrants are crystals that can be formed from the elements of the frit, the size of which (ideally close to the wavelength of the light) allows them to reflect the light in a scattered manner on the surface of the enamel and give a matt or satin effect. Such crystals are, for example, zinc silicates of the ZnSiO₃ type, wollastonite (CaSiO₃), diopside (CaMgSi₂O₆) or anorthite (CaAl₂Si₂O₈). These crystals may also give the enamel mechanical properties such as abrasion resistance properties.

The process according to the invention makes it possible to generate in situ, easily and in a very controlled manner, these agents for modifying the optical properties thanks to the precise control of the temperatures in the tanks and to the very high thermal homogeneity in each tank due to the intense agitation generated by the submerged burner. The crystallization of these agents from the glass frit requires in fact a low temperature, perfectly suited to the nature of the crystals that it is desired to form, whereas the control of the size of the crystals (essential for optimizing their optical effect) requires a perfectly uniform and controlled temperature. The process according to the invention therefore has a very considerable advantage over the process normally used to manufacture ceramic enameling frits, for which the presence of an overhead burner and flow of the glass as a thin layer without mixing do not allow precise temperature control. The step of controlled crystallization of the agents for modifying the optical properties is advantageously carried out in the last tank, the one heated to the lowest temperature, preferably the second or third tank.

The subject of the invention is therefore also a process for producing frits by melting in a furnace comprising at least two tanks in series, each comprising at least one burner submerged in the molten materials, said process comprising, preferably in the final tank, a step of controlled crystallization of coloring agents, opacifiers or delustrants, especially crystals based on zirconia (ZrO₂), zircon (ZrSiO₄) or titanium oxide (TiO₂) optionally doped with ions of transition metals or rare earths, or else ZnSiO₃, wollastonite (CaSiO₃), diopside (CaMgSi₂O₆) or anorthite (CaAl₂Si₂O₈) crystals.

Furthermore, the step for controlled crystallization of titanium oxide, particularly in anatase form, (or the addition of such pigments that have already been crystallized) makes it possible to give the enamel, thanks to its photocatalytic and photo-induced hydrophilicity properties, antisoiling, antibacterial, antifungal and antifogging properties. These properties are highly desirable in the case of ceramics intended for covering floors and walls, especially in a wet environment such as in bathrooms. In the case of tiling exposed to water splashes for example, the photo-induced hydrophilicity of the titanium oxide allows water to flow away rapidly and prevents the stagnation of water drops, which usually deposit mineral stains when they dry.

This controlled crystallization step may also allow larger crystals to form in the frit (with a size of around a few tens or hundreds of microns), which give the coverings coated with an enamel formed from such a frit antislip properties.

This crystallization can then continue during enamel firing, depending on the time and temperature conditions of said firing. The process according to the invention allows this to be taken into account by reducing the residence time and/or by modifying the temperature of the tank in which the crystallization takes place, so as to form smaller crystals. The advantage of the process therefore lies in the fact that uniformly sized crystals have been formed during melting of the frit, which crystals can then, during firing, serve as nucleating agents and promote bulk (“homogeneous”) crystallization as opposed to heterogeneous crystallization that form from the surface. In some cases, the nature of the crystals produced during firing of the enamel may even be different from that of the crystals produced during the step of the process according to the invention. For example, very small crystals (for example with a size of a few tens of nanometers, and therefore inducing no optical effect) may be nucleated during the crystallization step of the process according to the invention, these crystals then serving as nucleating agents during firing of the enamel and therefore promoting homogeneous crystallization of the desired crystalline phase, with a very narrow crystal size distribution. These nucleating agents may for example be TiO₂, ZrO₂, or ZrSiO₄ crystals or spinel-type phases containing titanium and/or iron, or chromium.

According to another embodiment, already crystallized mineral pigments may be added to a tank in which the temperature is quite low, thereby making it possible, on the one hand, to prevent said pigments from melting and, on the other hand, to intimately mix said pigments with the glass frit by the agitation resulting from the submerged burner.

The subject of the invention is therefore also a process for producing frits by melting in a furnace comprising at least two tanks in series, each having at least one burner submerged in the molten materials, said process comprising, preferably in the last tank, a step of adding mineral pigments, especially doped spinels, zirconias or zircons, such as vanadium-doped or praseodymium-doped CoAl₂O₄, 3CaO.Cr₂O₃.3SiO₂, ZrSiO₄, vanadium-doped ZrO₂ or (Zn,Fe)(Fe,Cr)₂O₄.

The invention also relates to a process for continuous production of silica-containing compositions by melting in a furnace comprising at least two tanks in series, said tanks each comprising at least one burner submerged in the molten materials, the first tank being charged with silica and silica fluxing agent, at least 90% of the silica and at least 90% of the silica fluxing agent being charged into the first tank, the furnace being fed with a fluidizing agent, at least 90% of which is introduced into the second tank of the furnace.

The glass batch materials other than the silica, silica fluxing agent and fluidizing agent are generally at least one oxide of a metal such as aluminum, magnesium, zirconium, titanium, manganese, praseodymium, iron, strontium and barium. These oxides may contribute to the coloration or to the opacification.

The submerged combustion technology (using submerged burners) may also allow the use, as raw material, of some of these oxides in reduced form, for example in metallic form. In particular, the metal may be at least one of the following metals: Zn, Cu, Cr, Ag. Oxidation of the metal is ensured by the oxidizer setting of the burners for the tank receiving these reduced raw materials. It is sufficient to establish an excess amount of oxygen, which corresponds to the amount needed to oxidize these materials. In general, this operates well if the amount of these reduced raw materials does not exceed a certain amount (less than 15% or even less than 10% of the total), as then their oxidation is rapid and does not affect the redox of the final glass. Another advantage of this use of materials in the reduced oxidation state is that the energy of oxidation of these materials is fully utilized: since oxidation takes place in the actual melting tank, the energy of oxidation is subtracted from the main energy—this therefore represents an energy saving. Thus, the invention also relates to a process for manufacturing an enameling frit for ceramics, especially in the form of tiles, in which at least one metal is added to the batch materials, said metal being oxidized during the melting process.

This use may be advantageous in the case where the metal is economically less expensive than the oxide.

The invention is especially suitable for the production of ceramic enameling frits such as sandstone, terracotta or earthenware tiles, for example those comprising the following oxides in the weight contents below:
50-70%, especially 50-60%, SiO₂;
4-20%, especially 4-8%, Al₂O₃;
0-10%, especially 3-6%, B₂O₃;
0-6%, especially 0-2%, Na₂O;
1-6%, especially 2-4%, K₂O;
3-20%, especially 7-15%, CaO;
0-3%, especially 0-2%, MgO;
0-15%, especially 0-5%, ZrO₂, and
0-15%, especially 2-10%, ZnO.

The furnace according to the invention comprises at least two tanks and preferably three tanks. When the furnace comprises two tanks, the first tank may be heated to a temperature ranging from 1230 to 1350° C. and the second tank to a temperature ranging from 900 to 1250° C. If required, the oxidation state of certain oxides (such as Cu or Cr oxides) is adjusted in the second tank. When the furnace comprises three tanks, the first tank may be heated to a temperature ranging from 1230 to 1350° C., the second tank heated to a temperature ranging from 1000° C. to 1300° C. and the third tank to a temperature ranging from 900° C. to 1150° C. If required, the oxidation state of certain oxides (such as Cu or Cr oxides) is adjusted in this third tank. In the case of a furnace having four tanks, no material is generally charged into the third tank except, when required, mineral pigments, which are not intended to be melted but only to be intimately mixed with the frit.

Thus, in general the furnace according to the invention comprises at least two tanks in series, or even three tanks in series, two of the tanks each having separate charging means, the first tank at least for charging with silica and silica fluxing agent and the second tank for charging with other materials, such as the fluidizing agent and/or at least one metal oxide.

According to a variant of the invention, the furnace comprises at least three tanks in series, the second being heated to a temperature ranging from 1000° C. to 1300° C. and the third to a temperature ranging from 900° C. to 1150° C., at least one metal oxide being introduced into the second tank of the furnace, the oxide having several oxidation states and the submerged burner(s) of the third tank having a sufficiently oxidizing flame for the oxidation state of the oxide to increase on passing from the second tank to the third.

According to another variant of the invention, the furnace comprises at least three tanks in series, the second being heated to a temperature ranging from 1000° C. to 1300° C. and the third to a temperature ranging from 900° C. to 1150° C. and precisely adjusted so that agents for modifying the optical and/or surface properties are crystallized in a controlled manner.

An additional advantage of the design of the multiple-tank furnace is the fact that it is possible to melt a given composition in the first tank and then to modify this composition using at least one following tank. This advantage is particularly important in the case of enameling frits for ceramic tiles (terracotta, earthenware, sandstone, etc), in which the large number of manufacturers and the variety of supports and enameling firing processes impose a large number and great variety of compositions. Within the context of the process according to the invention, it is possible for example to melt a single base composition in the first tank and then to modify this composition by additions made in the subsequent tank(s) so as to precisely adapt it to the requirements of the final customer. The base oxides are for example SiO₂, Al₂O₃, CaO and MgO, while the oxides ZnO and ZrO₂ often used to give particular optical properties may be added to the second tank. The process according to the invention therefore allows very great flexibility.

The various tanks of the furnace may for example each have a useful volume (that is to say equal to the volume of glass contained therein) ranging from 100 to 500 liters. In particular, in the case of a three-tank furnace, the first tank may have a useful volume ranging from 250 to 350 liters, the second a useful volume ranging from 150 to 250 liters and the third a useful volume ranging from 100 to 200 liters. Above the useful volume occupied by the glass, it is recommended to provide a large free volume for each tank, for example ranging from 0.3 to 1 times the useful volume of said tank.

The glass flows out from the first tank toward the last one by gravity. The various tanks in series are connected by channels or spillways.

The tanks may have any suitable shape they may be square, rectangular, polygonal or even circular in cross section. The cylindrical shape (circular cross section, with the axis of the cylinder being vertical) is preferred as it has the advantage that the glass is more effectively homogenized (fewer unagitated dead volumes). This cylindrical shape also has the advantage of being able to use unfashioned refractories for making up the lining of the walls, such as the use of a refractory concrete having a hydraulic binder.

These tanks may be cooled by making water run over their external surface or by a continuous water-circulation pipe wound around and welded to said metal plate. According to another embodiment, the tanks may be cooled without any water, simply by the fact that the metal casing is provided with cooling fins, at least one of the fins preferably being at least partly horizontal and going around the furnace about its vertical axis.

Upon leaving the furnace according to the invention, the molten mass may be conveyed into a feeder conventionally heated by radiation to improve the refining, or toward a refining zone. In such a refining zone, the glass is spread out so as to have a shallow depth, for example ranging from 3 mm to 1 cm, and heated so as to be effectively degassed. This refining step is generally carried out between 1050 and 1200° C.

Thus, the invention also relates to a device for producing glass compositions comprising a furnace according to the invention followed by a feeder or a refining zone.

The materials may be charged into the furnace using a feed screw.

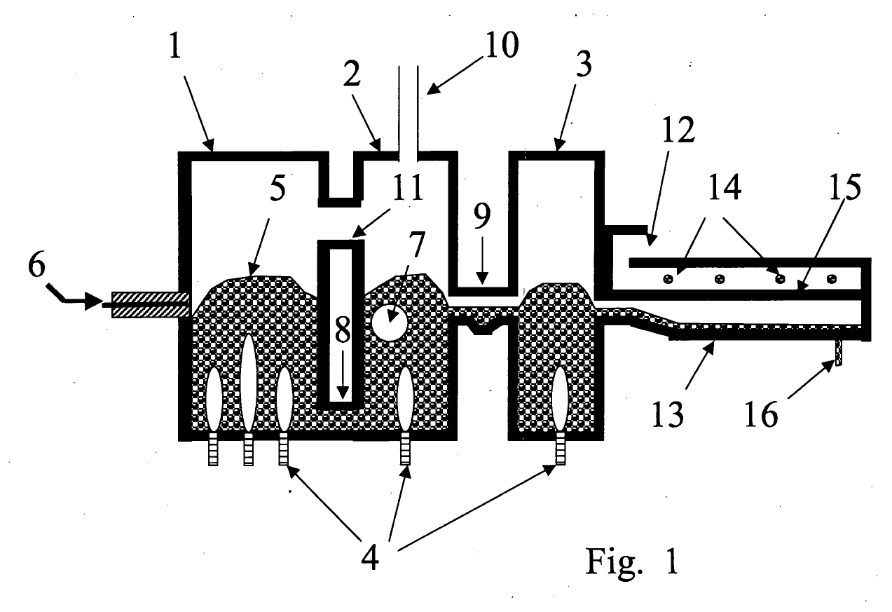

FIG. 1 shows a furnace comprising three tanks (1, 2, 3) according to the invention. These tanks are equipped with submerged burners 4, the gases from which make the mass of glass foamy. The level of the glass is indicated by 5. The silica and the silica fluxing agent are charged into the first tank at 6. The fluidizing agent and the other oxides are charged into the second tank at 7. The glass passes from the first tank to the second tank via the channel 8 and from the second tank to the third tank via the spillway 9. The second tank is equipped with a stack 10 for discharging the flue gases. The third tank may be used for the addition of mineral pigments or else for the controlled crystallization of agents for modifying the optical properties (coloring agents, opacifiers, delustrants). The glass leaves the third tank, to undergo a refining step in the refining zone 13. This refining zone is heated indirectly by burners 14 through a refractory stone 15. Such an arrangement also helps to reduce fly-off. The flue gases from the burners 14 are discharged via the opening 12. The final frit composition is then discharged at 16 before going onto a rolling station (not shown) for obtaining small frit squares that can be easily ground. Wet grinding is also possible.

According to this furnace configuration, and within the context of producing a glass frit for enameling earthenware tiles, the first tank may be heated to 1300° C., the second to 1250° C. and the third to 1130° C. The glass frit produced has the following composition, expressed in percentages by weight:
SiO₂ 55.4%
Al₂O₃ 14.6%
B₂O₃ 1%
CaO 20.1%
ZnO 2.1%
Na₂O 4.8%
K₂O 2%.

By introducing the B₂O₃ and ZnO into the second tank, the amount of fly-off remains limited, about 10% by weight relative to the oxides introduced. The uniform and precisely controlled temperature in the third tank allows anorthite (CaAl₂Si₂O₈) crystals to crystallize from the glass bath. These crystals, with a uniform size of about 0.5 microns, which then grow to 0.5 microns during the firing step, give the fired enamel layer a matt or satin appearance.

1. A process for the continuous production of glass frit compositions containing silica and intended for the enameling of ceramics by melting in a furnace comprising at least two tanks in series, said tanks each comprising at least one burner submerged in the molten materials, the first tank being charged with silica and silica fluxing agent.

2. The process as claimed in claim 1, wherein at least 90% of the silica and at least 90% of the silica fluxing agent are charged into the first tank.

3. The process as claimed in claim 1, wherein the silica carrier is coarse sand having a median particle size of more than 100 microns.

4. The process as claimed in claim 1, wherein the furnace is fed with a fluidizing agent, at least 90% of which is introduced into the second tank of the furnace.

5. The process as claimed in claim 1, wherein the first tank is heated to a higher temperature than the other tank(s) of the furnace.

6. The process as claimed claim 5, wherein the temperature difference between the first tank and the other tank(s) is at least 40° C.

7. The process as claimed in claim 6, wherein the first tank is heated to a temperature ranging from 1230 to 1350° C. and in that the other tank or tanks are heated to a temperature of at most 1300° C.

8. The process as claimed in claim 7, wherein the furnace comprises at least three tanks in series, the second being heated to a temperature ranging from 1000° C. to 1300° C. and the third to a temperature ranging from 900° C. to 1150° C.

9. The process as claimed in claim 1, wherein the final composition comprises the following oxides in the weight contents below:
50-70%, especially 50-60%, SiO₂;
4-20%, especially 4-8%, Al₂O₃;
0-10%, especially 3-6%, B₂O₃;
0-6%, especially 0-2%, Na₂O;
1-6%, especially 2-4%, K₂O;
3-20%, especially 7-15%, CaO;
0-3%, especially 0-2%, MgO;
0-15%, especially 0-5%, ZrO₂, and
0-15%, especially 2-10%, ZnO.

10. The process as claimed in claim 1, wherein at least one oxide of a metal is introduced into the second tank of the furnace.

11. The process as claimed in claim 1, wherein at least one metal is added to the batch materials, said metal being oxidized during the melting process.

12. The process as claimed in claim 1, wherein it includes a step for the controlled crystallization of coloring agents, opacifiers or delustrants.

13. The process as claimed in claim 12, wherein the crystals formed are based on zirconia (ZrO₂), zircon (ZrSiO₄) or titanium oxide (TiO₂) optionally doped with ions of transition metals or rare earths, or else ZnSiO₃, wollastonite (CaSiO₃), diopside (CaMgSi₂O₆) or anorthite (CaAl₂Si₂O₈) crystals.

14. The process as claimed in claim 13, wherein the TiO₂ crystals are crystallized in anatase form so as to give the enamel antisoiling, antibacterial, antifungal and antifogging properties.

15. The process as claimed in claim 1, wherein it includes a step of adding mineral pigments.

16. The process as claimed in claim 15, wherein the mineral pigments are doped spinels, zirconias or zircons.

17. A glass frit for enameling terracotta, sandstone or earthenware, obtained by the process of claim 1.

18. A furnace for the continuous melting of a silica-containing composition, said furnace comprising at least two tanks in series, said tanks each having at least one burner submerged in the molten material.

19. The furnace as claimed in claim 18, wherein it comprises at least three tanks in series.

20. The furnace as claimed in claim 18, wherein two of the tanks each have separate charging means.

21. The furnace as claimed in claim 18, wherein it includes a refractory lining in contact with the molten glass, a metal plate being placed behind said refractory.

22. The furnace as claimed in claim 21, wherein the refractory lining is made of molded refractory concrete.

23. The furnace as claimed in claim 22, wherein the metal casing is provided with cooling fins at least one of the fins preferably being at least partly horizontal and going around the furnace about its vertical axis.

24. An installation for producing glass compositions, comprising a furnace as claimed in claim 18, followed by a feeder or a refining zone.
